(19) United States
(12) Patent Application Publication
(10) Pub. No.: US 2003/0047002 A1
(43) Pub. Date: Mar. 13, 2003

(54) MEMS BASED ANGULAR ACCELEROMETER

(76) Inventors: STEVEN W. ARMS, WILLISTON, VT (US); CHRISTOPHER P. TOWNSEND, SHELBURNE, VT (US)

Correspondence Address: JAMES MARC LEAS, 37 BUTLER DRIVE, S. BURLINGTON, VT, 05403, US

(21) Appl. No.: 09/429,471

(22) Filed: Oct. 28, 1999

Related U.S. Application Data
(60) Provisional application No. 60/106,014, filed on Oct. 28, 1998.

(51) Int. Cl. G01P 3/20; G01P 15/14

(52) U.S. Cl. 73/504.17; 73/501

(57) ABSTRACT

A micro-electromechanical system (MEMS) is described for economical sensing of angular accelerations, especially for use in biomechanical applications. The device design is inspired by that of the semi-circular canals of the inner ear, utilizing a fluid filled channel and differential pressure transducer. Using modem fabrication techniques, very sensitive angular acceleration instruments may be realized. By combining these fast response sensors with other sensors, such as DC response linear accelerometers, allows broader frequencies of human motion to be monitored.

### BACKGROUND OF THE INVENTION

The development of closed loop control systems for neurological applications depends on sensors in order to provide static and dynamic feedback. Furthermore, improved medical tracking devices, virtual reality body part tracking, sporting equipment, games, and toys could employ dynamic sensors to provide feedback or provide data used for accurate measurement of human, animal, machine, and structural performance.

Solid state, sourceless inclination and orientation sensors have been developed which are capable of providing static and slow dynamic (4-6 Hz) angular position feedback (3DM, MicroStrain, Inc.). These systems may employ adaptive digital filters, which enhance their performance in the face of vibration and other dynamic influences (Townsend et al., ICAST Int'l Conf. on Adaptive Structures, Boston, October 1998).

However, there is a often a need to accurately track body position at higher mechanical input frequencies. In order to accomplish this, dynamic sensors are needed, such as angular rate gyros and angular accelerometers. Ideally, these devices would be small, inexpensive, and immune to signal contamination (artifact) caused by linear accelerations.

MEMS devices have the potential to provide high performance at low cost, since they are produced using semiconductor processing methods.

### BRIEF DESCRIPTION OF THE PRIOR ART

Angular accelerometers are used to provide signals that are proportional to angular accelerations, and when integrated twice, can provide signals that are proportional to the angular displacement about an axis of rotation.

Angular accelerometers that utilize fluid fill channels have been described. U.S. Pat. No. 4,361,040 and U.S. Pat. No. 4,002,077 uses a fluid filled cavity with an inertial mass supported by a hydrostatic bearing. When the housing rotates relative to the inertial mass, a pressure is developed by a viscous pumping effect. The invention described here is much simpler in that now inertial mass is necessary to measure the angular acceleration. In addition, no expensive mechanical bearings are required. U.S. Pat. No. 3,789,935 describes an angular accelerometer that utilizes a fluid in a tube with multiple barriers that are diametrically opposed. This method is more complex than the device that is described herein, as it requires two pressure sensing diaphragms, one located at each barrier, versus the single pressure sensing diaphragm at a single barrier that is required in this design. U.S. Pat. No. 4,232,553 utilizes a toroid filled with fluid and measures angular acceleration by measuring the flow of the fluid using thermally sensitive elements within the fluid channel. This system requires flow of the fluid in relation to the thermally sensitive elements, which reduces the frequency response of the accelerometer. In addition, the thermal elements require much more power than a pressure sensor, and can exhibit a significant warm up time upon initial power up of the device.

### OBJECTS AND SUMMARY OF THE INVENTION

Our objective was to design and construct a low cost angular accelerometer based on off-the-shelf, low cost MEMS based pressure transducers. Furthermore, we employed a test apparatus capable of delivering a controlled sinusoidal angular acceleration over a range of input frequencies. Using this system, we may obtain test data of the angular accelerometer's performance, esp. sensitivity, bandwidth, and immunity to linear acceleration errors. Finally, it is our object to teach a method for combining angular accelerometers with DC (gravity referenced) accelerometers for improved static and dynamic angular motion measurement; esp. for body segment motion measurement (FIG. 1).

Our MEMS angular accelerometer assembly (FIG. 3) was inspired by the structure of the inner ear (FIG. 2). Within the inner ear, labyrinth semicircular canals interact with the cupula to provide a sensitive response to head angular accelerations. This “rapid and robust” system system is critical to the function of the vestibulo-ocular reflex. In vivo experimental observations suggest that the cupula is deformed like a diaphragm, adhering firmly to the ampular wall during physiologic stimulation (mechanotransduction in the vestibular labyrinth, NIH guide, Vol 22, Nos. 11 & 42, Nov 1993).

A mechanical analog of one of the semicircular canal structures of the inner ear was constructed using rigid tubing, mineral oil, and a $25 differential pressure transducer (Silicon Microstructures, 1 psi full scale range). The tubing was constrained in a circular channel approx. 30 mm in diameter. Oil was used (rather than water) in order to protect the transducer from potential corrosion. The tubing and sensor were carefully filled to avoid inclusion of air bubbles. The device was mounted to a PC board to facilitate test, and the sensor's differential output was conditioned with an instrumentation amplifier (gain of 1000). Note that the device is sensitive to angular accelerations about axes normal to the plane of its circular channel.

Linear vibration test equipment was used to develop a test platform (FIG. 4). This platform included: an exciter, controller, power amplifier (Labworks, Costa Mesa, Calif.); were modified to provide a sinusoidal angular displacement. A linear position gauging transducer (DVRT, MicroStrain, Burlington, Vt.) was used to measure the motion of the test platform (and attached MAA).

Our qualitative examinations showed that the accelerometer was extremely sensitive to angular accelerations, and relatively insensitive to linear movement. No response was observed at constant angular rates; the device performed as an angular accelerometer as expected. Phase errors were not observed on the dual trace oscilloscope at any of the frequencies tested (5-20 Hz), and the response of the unit to linear accelerations was minimal.

The MEMS differential pressure based angular accelerometer may be employed for use in very low cost angle tracking, body position tracking, and motion analysis.

### BRIEF DESCRIPTION OF THE DRAWINGS

FIG. 1) Biomechanics Application for Wearable Linear and Angular Accelerometers

FIG. 2) Drawing of Structure of Inner Ear

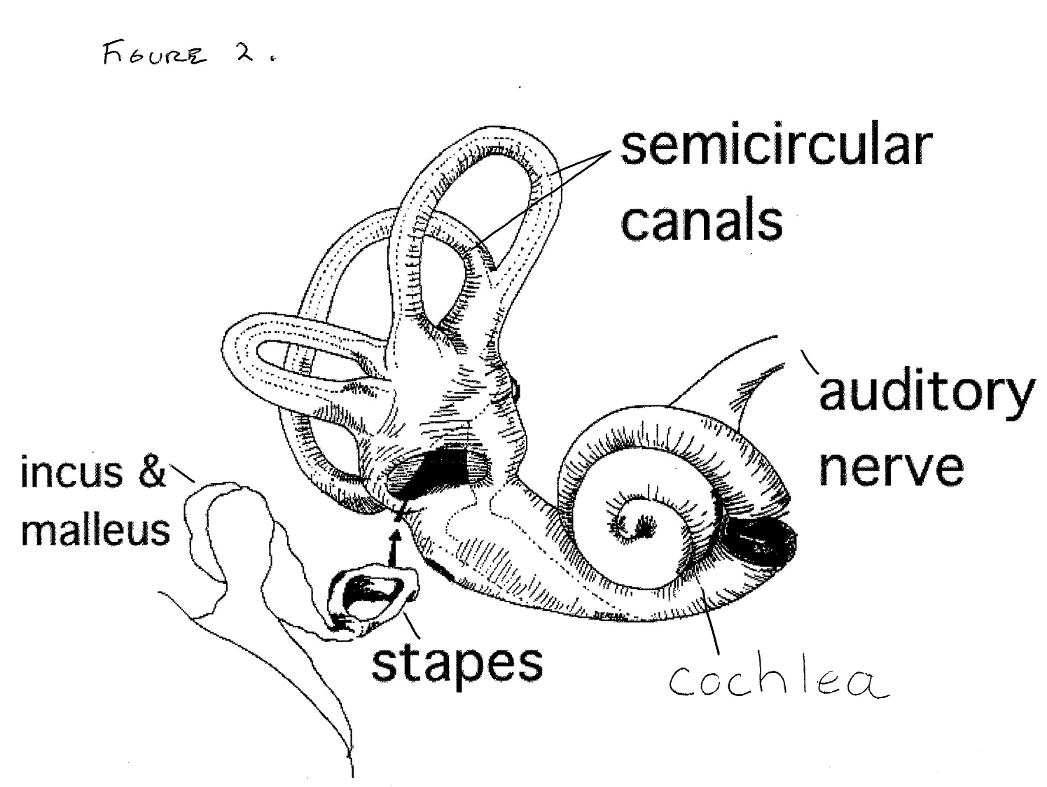

FIG. 3) MEMS Angular Accelerometer Structure

FIG. 4) Dynamic Testing System for Angular Accelerometer

FIG. 5) Results from 15 Hz Sinusoidal Input

FIG. 6) Block diagram of combined DC and AC response accelerometers for angular motion measurement

### DETAILED DESCRIPTION OF THE INVENTION

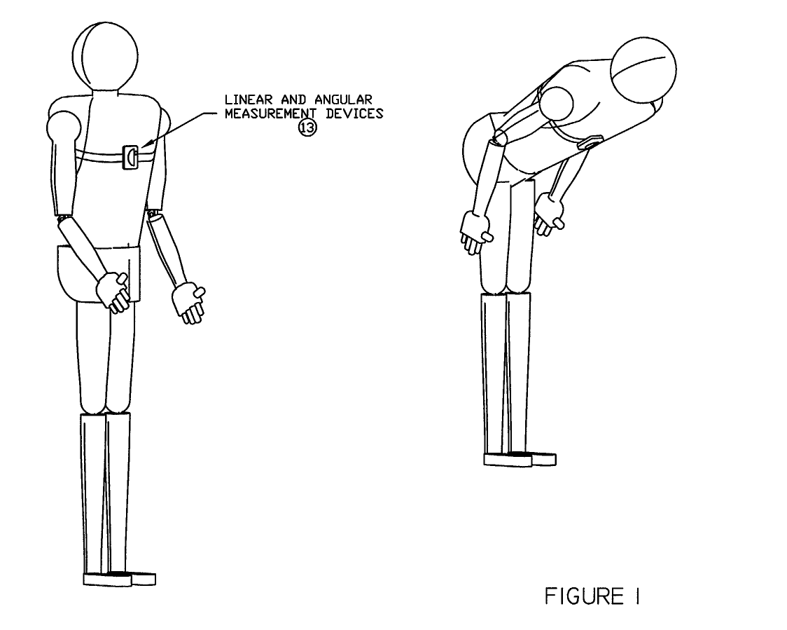

FIG. 1 depicts a typical application of the MEMS angular accelerometers; showing one or more sensing nodes as might be worn by a person undergoing biomechanical testing or performance monitoring. Note that both DC (steady state) linear accelerometers may be employed along with AC (dynamic) response angular accelerometers. We have previously described a method for static and quasi-static body segment angular position measurement in our Provisional Patent Application, serial No. 60/032,938, filed Dec. 9, 1996, entitled “Miniaturized Inclinometer for Angle Measurement with Accurate Measurement Indicator”; and is incorporated herein by way of reference. This is advantageous since both static and dynamic movements may be tracked from a single limb segment's sensor cluster.

The angular accelerometer (10) may be enclosed in a wearable package (13) which may also contain DC response accelerometers. These accelerometers may be combined to provide both static and dynamic angular motion data from a body segment. It is important to note that FIG. 1 depicts trunk angular motion measurement only, but that other segments of the body could be measured by placing one or more units on other body segments.

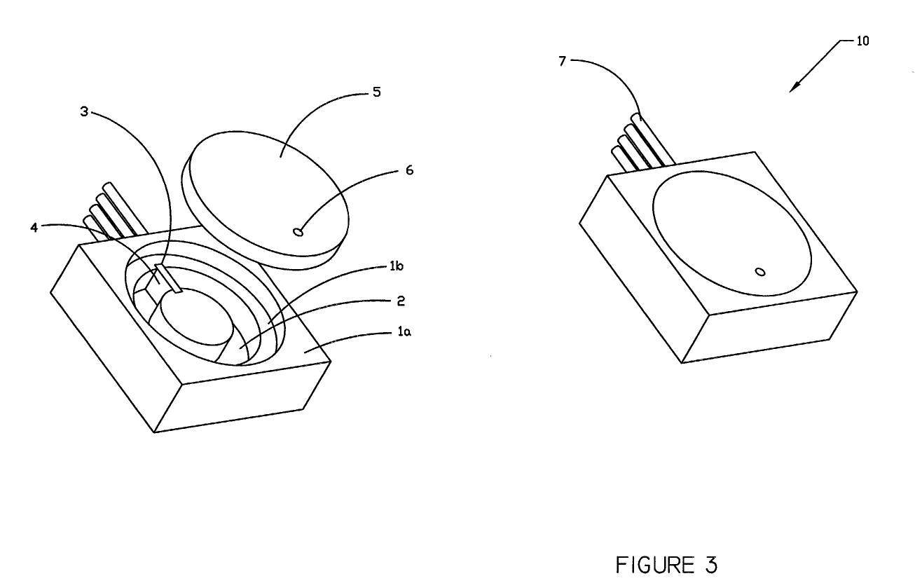

FIG. 3 describes the three dimensional structure of the MEMS angular accelerometer (10). The circular channel (2) is separated by a pressure sensitive diaphragm, which is integral to a MEMS differential pressure transducer (4). The diaphragm is comprised of strain sensitive piezoresistive or piezoelectric elements, which may be bonded or directly deposited on the diaphragm using semiconductor processing techniques. The circular channel (2) is filled with a fluid, such as oil. When the housing (1a) is subjected to an angular acceleration about an axis orthogonal to the plane of the circular channel (2), a pressure differential is created at the diaphragm of the pressure transducer (4), and this pressure difference is sensed by the transducer's strain sensitive elements. This signal may be amplified and recorded for use in angular motion analysis.

To realize the advantages of MEMS processing, the circular channel (2) may be created in the angular accelerometer housing (1a) using micro machining techniques. The housing may be made of a variety of materials, including: silicon, stainless steel, or polymer. The channel (2) has a slot (3) which accepts the MEMS differential pressure transducer (4). The housing (1a) also has a receiving counter bore (1b) to accept a cover (5). The cover (5) includes an aperture (6) for filling of the channel (2) with fluid. The fluid may be comprised of mineral oil or other non-reactive, freely flowing material, preferably one which will protect the housing (1a), cover (5), and differential pressure transducer (4) from corrosion. Both the cover (5) and the aperture (6) may be sealed to the housing (la) using epoxies, laser welding, or electron beam welding techniques. The aperture (6) is sealed after fluid has filled the sealed channel (2), without inclusion of trapped air within the channel (2). Output leads (7) from the differential pressure transducer (4) exit from the side of the housing (1a) and may be sealed using epoxies or hermetic feed throughs. Four output leads are shown, these typically provide two excitation leads and two output signal leads, but this number of lead wires could easily be reduced to three with the addition of an on-board amplifier, at the expense of increased complexity of the pressure transducer.

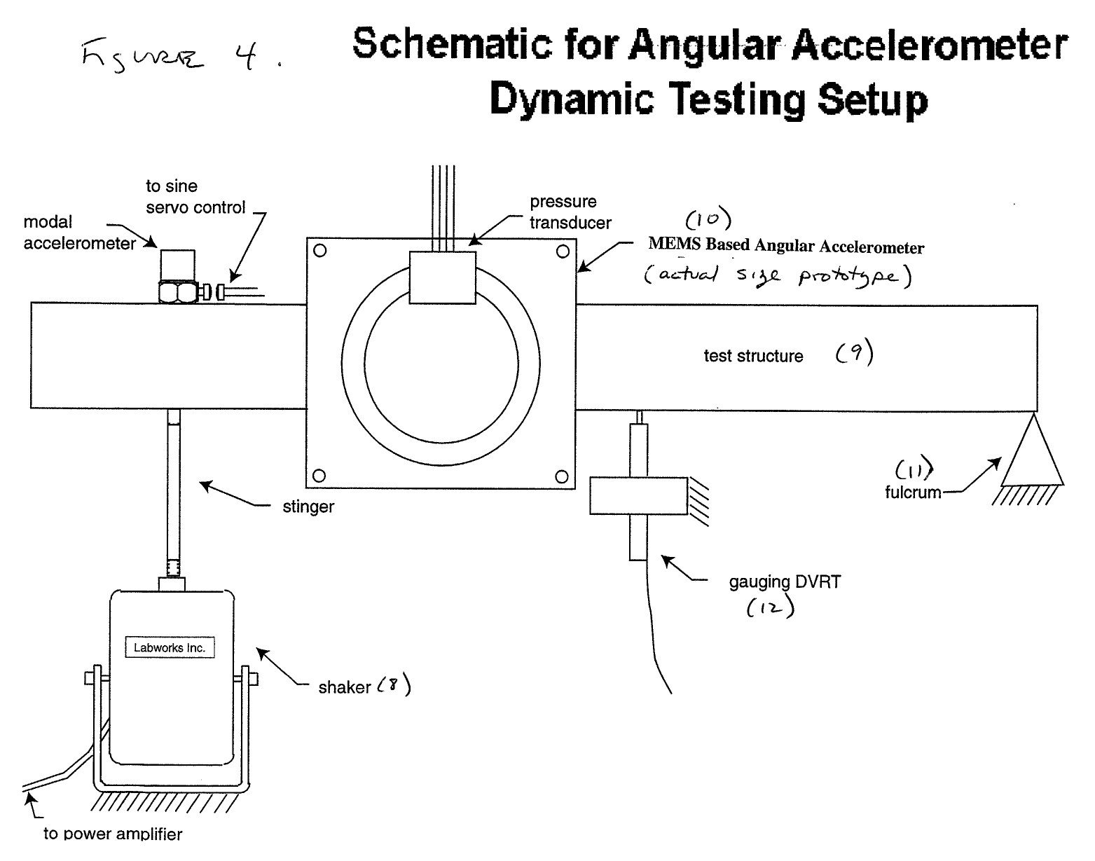

FIG. 4 is a diagram of a testing setup used to input known angular accelerations to the MEMS angular accelerometer. A voice coil actuator (8) is used to deliver sinusoidal movements to the mounting bar (9), which is pivoted about a fixed axis of rotation (11). A linear displacement transducer (12) is used to measure the motion of the bar relative to the pivot point, or axis (11). The angular accelerometer (10) is affixed to the mounting bar, and therefore experiences a sinusoidal angular acceleration.

Angular acceleration data were collected at 20, 15, 10, and 5 Hz with the novel angular accelerometer mounted to be sensitive to the angular motion. The transducer was also tested in a linear fashion, in a direction along its sensitive axis, to test the influence of linear accelerations.

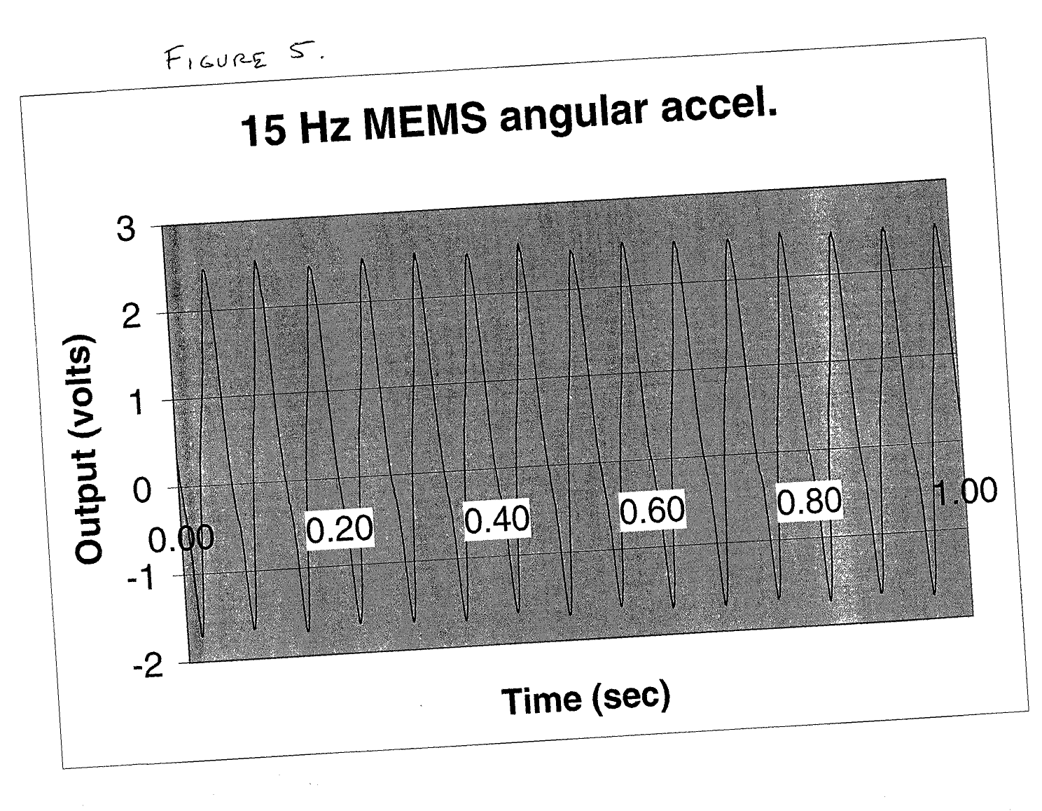

Data from the 15 Hz tests are provided in FIGS. 5. These data are typical of what we observed at 10 and 20 Hz as well. Phase errors were not observed on the dual trace oscilloscope at any of the frequencies tested.

The response of the unit to linear accelerations was minimal; outputs were down approximately 98% for tests run at similar frequencies and displacements.

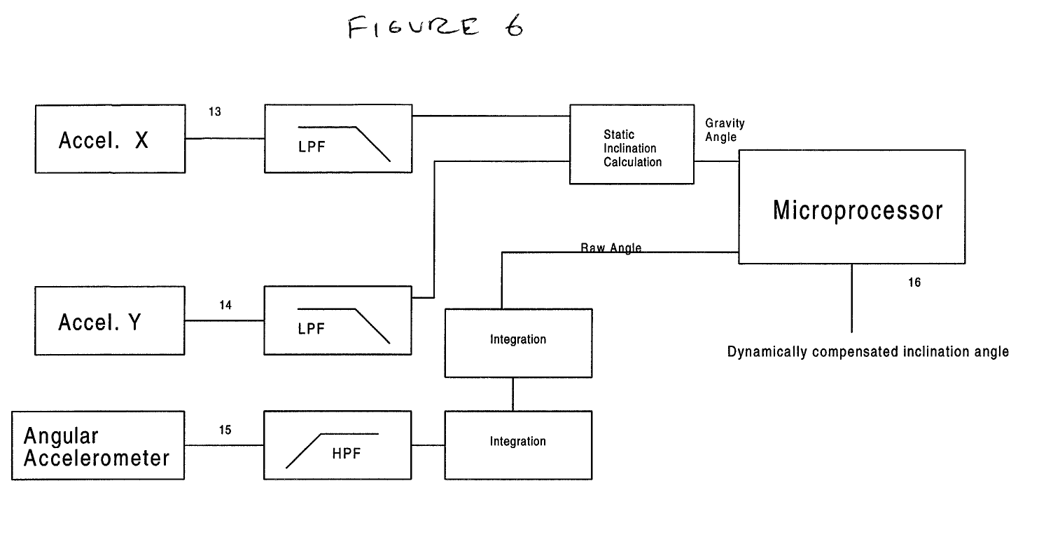

It is also advantageous to use the angular accelerometer previously described as a means to calculate angular displacements (FIG. 6). Two linear accelerometers (13 ,14) are utilized to calculate true static angle relative to gravity. When combined with the double integrated output of the angular accelerometer (15) and a microprocessor for error correction (16) then a dynamically compensated inclination angle can be calculated.

We claim:

1. An angular accelerometer comprising:
a circular channel;
a differential pressure sensor;
said channel is filled with a fluid.

2. An angle measurement system according to claim 1 wherein:
said differential pressure sensor comprises means for measuring pressure imparted by fluid under the influence of angular acceleration;.
two electronic integrators to calculate the angular position from the output of the angular accelerometer;
having two or more linear accelerometers with DC response;
having a low pass filter that filters the linear accelerometers output;
having a high pass filter that filters the angular accelerometer;
having a microprocessor;
having a microprocessor based digital correction algorithm to calculate true;
and said angle measurement system providing angle relative to gravity, compensating for the drift of the angular accelerometer and integration stage.

2. An angle measurement system according to claim 2 wherein;
said integrators are implemented in software by the microprocessor,
said low pass filter is implemented in software by the microprocessor,
said high pass filter is implemented in software by the microprocessor.

3. The angular accelerometer as in claim 1 wherein,
the circular channel and pressure sensor are micromachined using a MEMS semiconductor process.

4. An angle measurement system according to claim 2 wherein,
networking means for communication between multiple units are incorporated
digital data communication hardware means,
firmware in the microprocessor that implements data networking means.
